(19) United States
(12) Patent Application Publication
(10) Pub. No.: US 2019/0308201 A1
(43) Pub. Date: Oct. 10, 2019

(54) VANE ELECTROSTATIC PRECIPTATOR (VEP) WITH CLEANABLE HORIZONTAL DISCHARGE ELECTRODES AND MOVABLE FLOATING

(71) Applicant: John P. Dunn, Horseheads, NY (US)

(72) Inventor: John P. Dunn, Horseheads, NY (US)

(21) Appl. No.: 15/932,684

(22) Filed: Apr. 9, 2018

(51) Int. Cl. B03C 3/12; B03C 3/36; B03C 3/47

(52) U.S. Cl. CPC B03C 3/12; B03C 2201/10; B03C 3/47; B03C 3/366

(57) ABSTRACT

A vane electrostatic precipitator includes a plurality of vanes and a plurality of horizontal discharge electrodes that follow the contour of the vane assembly and are located in front of the vane electrodes. The horizontal discharge electrodes are parallel to the vane assembly, and are located on an angle matching an operating angle of the vane assembly. The precipitator also preferably includes a plurality of concentric, moveable tubular scrapers that keep the horizontal discharge electrodes clean during the process.

### DESCRIPTION OF RELATED ART

Standard electrostatic precipitators use vertical, parallel plates with vertical discharge electrodes centrally located between the plates.

Prior art vane electrostatic precipitators are disclosed in U.S. Pat. Nos. 8,894,745-9,039,815-9,073,062 and 9,238,230, all incorporated herein by reference. Prior art versions of vane electrostatic precipitators use vertical, parallel plates set at a specific operating angle with the discharge electrodes set vertically in front of the vane electrodes.

Prior art of using a plurality of horizontal discharge electrodes is described in the authors U.S. Pat. No. 9,789,495, Oct. 17, 2017. The horizontal discharge electrodes are located in front of a plurality of vertical rotatable disc electrodes, not vane electrodes.

### FIELD OF THE INVENTION

The invention pertains to the field of electrostatic precipitators. More particularly, the invention pertains to vane electrode precipitators with horizontal discharge electrodes that are cleanable using floatable tubular scrapers.

### REFERENCE CITED

### U.S. Patents Documents

| | | |
|---|---|---|
| 1,843,510 | Feb. 2, 1932 | Hale |
| 3,109,720 | Nov. 5, 1963 | Cumming |
| 3,354,617 | Nov. 28, 1967 | Hoising |
| 3,483,670 | Dec. 16, 1969 | Quintilian |
| 3,703,799 | Nov. 28, 1972 | Humpheys |
| 4,375,364 | Mar. 1, 1983 | Van Hoesen |
| 4,412,850 | Nov. 1, 1983 | Kurata |
| 4,502,872 | Mar. 3, 1983 | Ivester |
| 4,521,229 | Jun. 4, 1985 | Baker |
| 6,709,484 | Mar. 23, 2004 | Lau |

### SUMMARY OF THE INVENTION

A vane electrostatic precipitator includes a plurality of vane electrodes and a plurality of horizontal discharge electrodes that follow the contour and operating angle of the vane electrodes of the vane assembly, and are located in front of the vane electrodes. The horizontal discharge electrodes are parallel to the vane assembly, and are located on an angle matching an operating angle of the vane assembly. The precipitator also preferably includes a plurality of concentric, moveable tubular scrapers that keep the horizontal discharge electrodes clean during the process.

### BRIEF DESCRIPTION OF THE DRAWINGS

FIG. 1a shows a cross sectional top view of a vane electrostatic precipitator, showing the relative position of the horizontal discharge wire electrodes in relation to the vane electrodes as well as the air flow over the vanes.

FIG. 1b shows the physical relation between the discharge electrode and the individual vanes and vane assembly.

FIG. 2 shows a cross sectional side view of a vane electrostatic precipitator, showing the horizontal discharge wire electrodes and the vertical location of the mechanism for moving the scrapers over the discharge wires.

FIG. 3 shows a cross sectional front view of a vane electrostatic precipitator, showing the horizontal discharge wire electrodes and the relative position of the discharge wire support structure.

FIG. 4 shows a top horizontal view of the expected electric field between the discharge electrodes and the vane electrodes.

FIG. 5 shows an altitude view of the expected electric field between the discharge electrodes and the vane electrodes.

FIG. 6 shows across sectional view of discharge electrodes that are open ended and no center support being used in an alternative embodiment.

FIG. 7 shows a cross sectional view of the discharger external enclosure and the tubular scraper. What is shown is the home position for the scrapers and scraper bar. The enclosure itself is located externally on the sides of the VEP.

FIG. 8 shows is a cross sectional top view of an experimental VEP developed for coal stoves.

FIG. 9a shows a cross sectional view of a floating tube scraper concept

FIG. 9b shows a cross sectional top view of the floating tube scraper seated between the forked support bars that is used to traverse the tube scraper over the discharge wire

FIG. 9c shows a vertical side view of the scraper forked support bar with the floating tube type scraper in operating position

FIG. 10a shows a vertical side view of the tube scraper bar with the tube scrapers fasten to the support bar

FIG. 10b shows a vertical front view of the tube scraper bar with the tube scrapers fasten to the support bar

### DETAILED DESCRIPTION OF THE INVENTION

The methods and devices described herein improve the performance of electrostatic precipitators in charging and collecting entrained particles from a gas stream. In some embodiments, the methods and devices are used in coal fired furnaces. The precipitator keeps the discharge and collecting electrodes clean during the process. The improved methods keep the discharge electrodes clean during the precipitating process.

The present devices and methods also facilitate maintenance of low air flow near the collecting plates so that charged particles drifting towards the plate are collected and when discharged from the plate arc collected by impact and nut re-entrained in the air stream. Using vane electrodes in the precipitator facilitates achievement of these functions.

In the embodiments described herein, the discharge electrodes are arranged horizontally (instead of vertically) in front of the vane electrodes. The discharge electrodes also follow the operating angle of the vane electrodes in the vane assembly. The horizontal angular arrangement of the discharge electrodes allows the use of shorter and smaller diameter discharge wire electrodes, resulting in less electrical power required for emission.

A primary objective of the devices and methods described herein is to keep the discharge electrodes clean during the precipitation process; use of horizontal wire discharge electrodes facilitates accomplishment of this objective. The horizontal discharge electrodes are located in front of the vane electrodes, close to the vane electrodes (preferably between 0.750″ to 2.0″ inches from the vane electrodes, depending on operating conditions and follow the contour of the operating angle of the vane assembly. The horizontal discharge wire electrodes can be supported at both ends and in the center by supports section. Another method is to have two separate horizontal discharge electrodes and are described further herein as a left and right scraper, with one end supported while the ends near the center are not supported or open ended.

The horizontal discharge electrodes are preferably scraped with floating tubular or tubular bar scrapers that are located on each side of the precipitator and out of the main air stream. The tubular scrapers slide over the horizontal discharge wire from the support side to the center support to remove any material that has attached to the surface of the horizontal discharge electrodes.

The horizontal discharge electrodes have low maintenance because the traveling support for the scraper tubes and the mechanism used to move the scraper tube support is located out of the main air flow. Horizontal discharge electrodes also allow for shorter wire length electrodes that follow the operating angle of vane assemblies resulting in an even shorter length of wire that needs to be cleaned. In addition, the preferred vertical, external location of the scraper mechanism for the horizontal discharge electrodes facilitates the replacement of the sliding tube scrapers.

Both the tubular type and bar type scrapers have dimensions that closely match the outside dimension of the discharge wire. As an example the clearance between the discharge wire sizes of 0.060″ of an inch (1.524 mm) would be between 0.0005″(0.013 mm) to 0.001″ (0.025 mm).

In some embodiments, the width of the vanes can vary from approximately 2.0″ inches (50.8 mm) to approximately 2 feet (609.6 mm), as well as within the vane assembly. The width variation depends on a number of operating parameters including, but not limited to, input gas velocity, particle concentration and structural requirements, etc.

In some embodiments, the horizontal discharge electrodes have a diameter of less than approximately 0.500 inches to reduce electrical power required for emission.

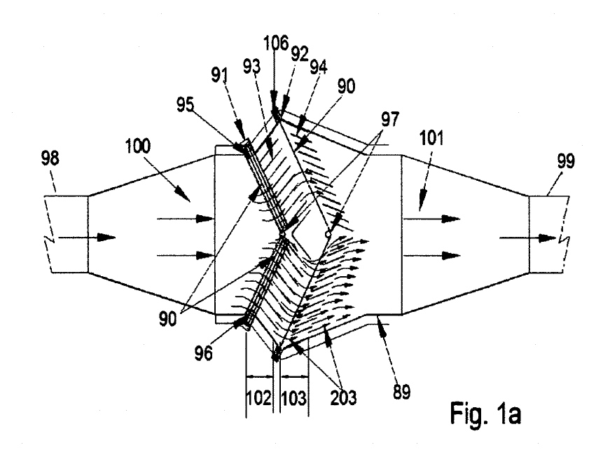

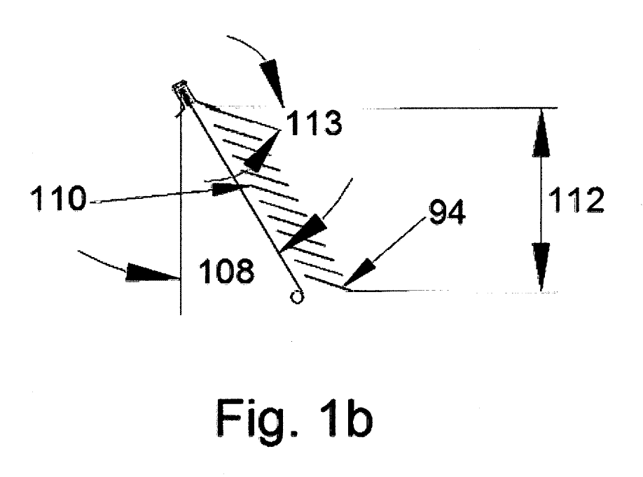

FIG. 1a is a cross sectional top view of a two stage 102, 203 vane electrostatic precipitator 89 with horizontal discharge electrodes 90 and vanes 93, 94. The horizontal discharge electrodes 90 replace the vertical discharge electrodes used in prior art vane electrostatic precipitators. The two stages 102 and 103 can be considered a field and can be repeated to meet larger CFM requirements.

FIG. 1b shows that the horizontal discharge electrodes 90 are parallel to the vane assemblies 112 and are located on an angle matching an operating angle 108 of the vane assemblies 112. The vane type electrode 94 have a leading edge 110 and operate at a separate angle 113 that is designed to induce drag on the entrained air flow.

FIG. 1a also shows the entrained air entering the precipitator at inlet 98 and exiting the precipitator at outlet 99. Air flow input 100 and outlet 101 are shown as well as the air flow pattern 203 through the vanes. A major advantage of horizontal discharge electrodes 90 is related to the width (not to the height or altitude) of the precipitator. The modified precipitator enhances the capability of using tubular scrapers 96 to keep the discharge electrodes 90 clean during the precipitating process.

The scrapers can be made from any number of different materials and may be tubular or be machined out of bar stock with a close fitting hole that matches the diameter of the discharge wire electrode 90 size. Factors to consider when choosing a material for the tubular scrapers 96 include wear resistance, as well as electrical and dimensional relation to the discharge wire electrode. For example both stainless steel tubing and alumina tubing can be used depending on how they are engineered into the structure. The preferred type of scraper is tubular scrapers 96 that can slide over the horizontal discharge electrodes 90 to remove deposited material.

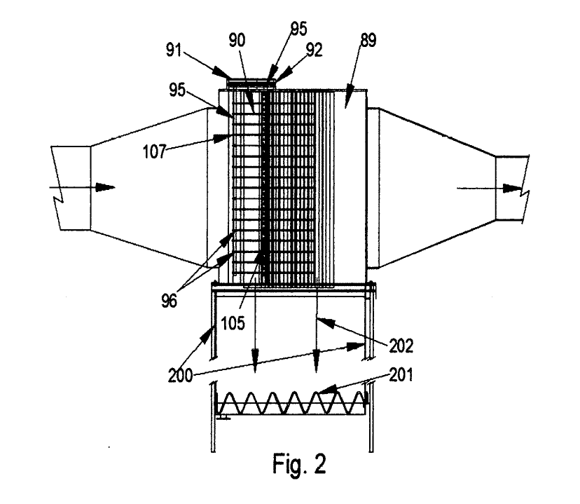

The horizontal discharge electrodes 90 are structurally mounted in the discharger support-structure 106 and traverse back and forth between the center discharger support bar 97 and the normal operating position 107 (see FIG. 2). The discharger support structure 106 and the apparatus for moving the scraper support bar 95 are located externally, in the enclosures 91, 92. For each stage 102, 203, the enclosure construction depends on the external structure and the enclosures for the stages 102, 203 could be different from each other because of external structural differences.

Several methods could be used to traverse the scraper support bar 95. As one example, the method partially shown is a linear actuator slide system 91 for the first group of vane electrodes 93. Another method could be used a slide mechanism activated by a motor driven acme screw.

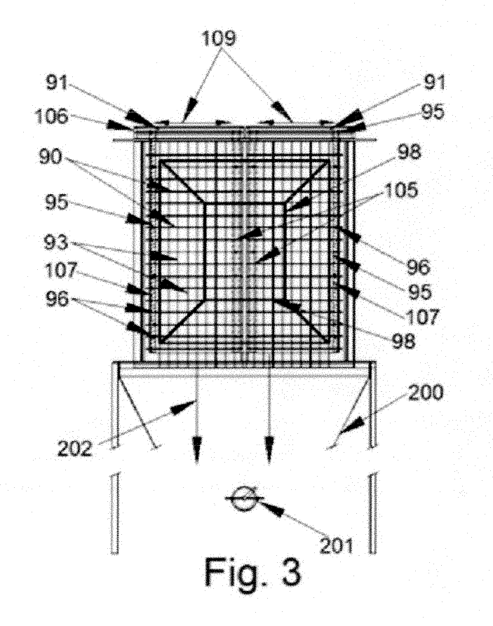

FIGS. 2 and 3 are cross sectional side views showing multiple horizontal discharge electrodes 90 and the initial operating position 107 of the tubular scrapers 96. An actuator slide mechanism 91 is located on top of the vane electrostatic precipitator and shows the extended position 105 of the scraper support bar 95.

FIGS. 2 and 3 also show a hopper 200 where dust on the vanes 93 falls 202 by gravity after being impacted and removed from the hopper 200 by a screw auger 201 into a collection device. In other embodiments, the particles can fall by gravity directly into a collection chamber.

FIG. 3 is across sectional front view of the vane electrostatic precipitator 89 showing a view of the first series of vanes 93 in relation to an input duct system 98. The location of the actuator/slide enclosure 91 and movement (arrows) show the scraper support bar 95 and the degree of travel 109 of the scraper support bar 95.

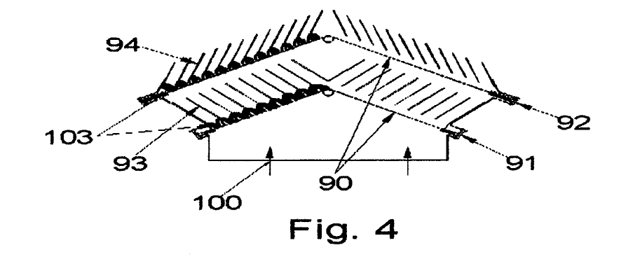

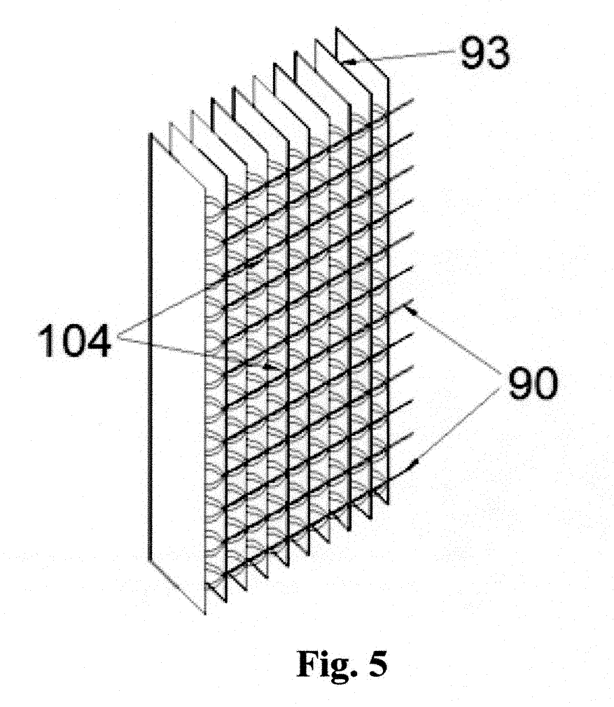

FIG. 4 is a top view showing the high voltage direct current electric field distribution 103 that is established between the discharge electrodes 0 and the vane electrodes 93, 94. FIG. 5 is an altitude isometric drawing showing the vertical electric field distribution 104 established between the discharge electrodes 90 and the vane electrodes 93.

FIGS. 4 and 5 show that, both in the horizontal or top view and the altitude view, particles passing through this area will be charged and be distributed over the vane electrodes 93 and 94.

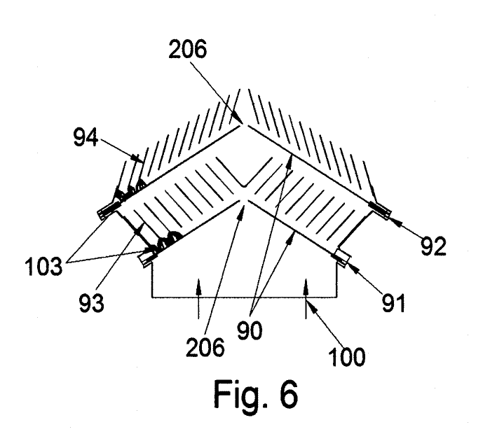

FIG. 6 is a top view showing two independent opposing discharging electrodes 90 that have open ends 206. This design allows for material that is being scraped off by the scraper support bar 95 to fall by gravity off the open end 206 into the hopper below.

It should be noted that, in the embodiment of FIG. 6, the discharge wire electrodes 90 have to be strong enough that they do not deflect towards the vane electrodes 93 or 94 when electrical power is applied. If the discharge wire electrodes 90 bow toward the vane electrodes 93 or 94, the uniformity of the electrical field distribution 103 would be adversely affected.

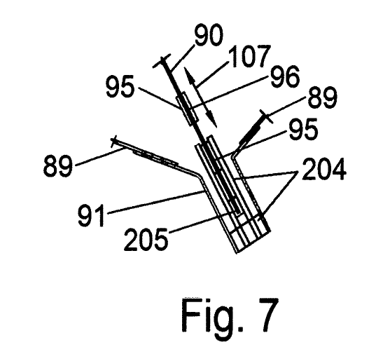

FIG. 7 shows a cross sectional view of a more detail view of the external discharger enclosure 91. The mechanism used to move the scraper tube support bar 95 is not shown but the travel is indicated by 107. Other components include the vertical high voltage direct current connector bar 205 and the dielectric material 204 used to support the discharge wire 90, the tubular scraper 96 and the scraper tube support bar 95 while 89 represents the main body of the VEP.

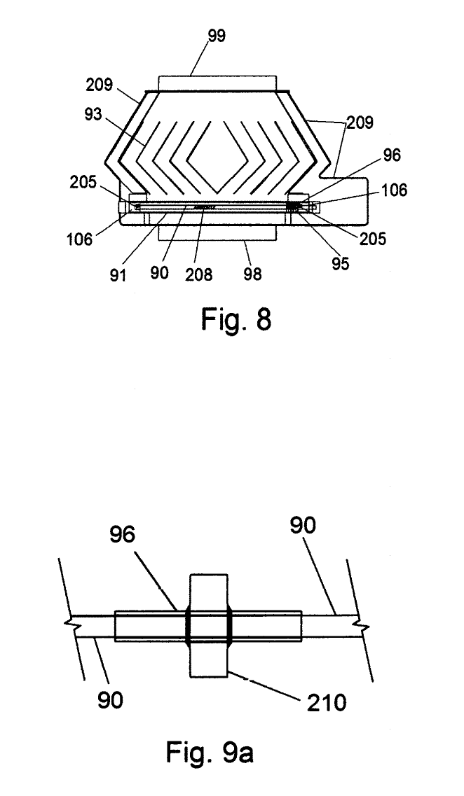

FIG. 8 is used to illustrate the location of the key elements of the VEP. Below the top plate 209 the discharge electrodes 90, the scraper support bar 95 the tubular scrapers 96 while on the sides the vertical HV connector bars 205 and the discharger support enclosure 106 are located. Above the top plate 209 the discharger enclosure 91 and the acme screw mechanism 208 for moving the scraper support 95 are located.

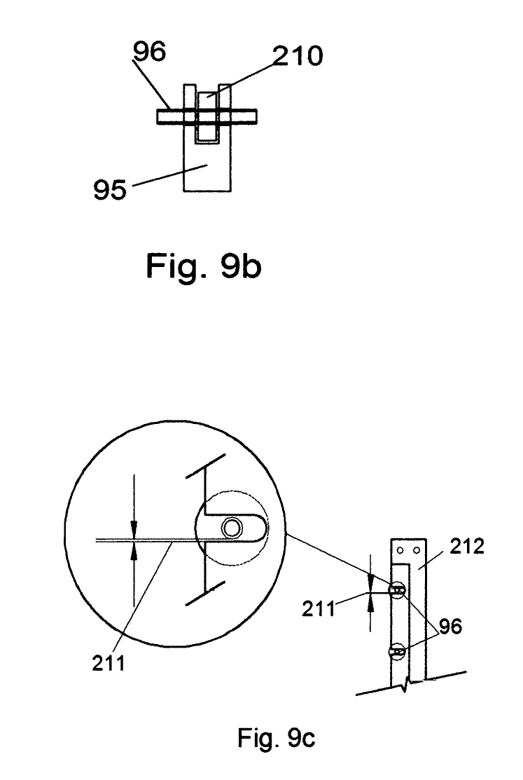

FIG. 9a is a more detail view of the preferred design of the floating type tubular scraper 96. The view shows the discharge electrode 90 and the floating type tube scraper 96 with a center disc 210 brazed perpendicular to the center of the floating type tube scraper 96. Pressure is applied to the disc 96 by the forked tube scraper motion bar 212, FIG. 9b, to move the floating type tube scraper 96.

FIG. 9b shows a top view of the floating type tube scraper 96 nested between the two prongs of the forked bar 212. Cleaning the discharge electrode wire 90 is accomplished by moving the support forked bar 95 with the floating type tube scraper 96 lateral over the discharger wire. This design compensates for miss alignment differences between the end connections and height differences between discharge electrodes 90. The forked bar 95 can be made from either conductive or a preferred non conductive material depending on the application.

FIG. 9c is a side view of the fork type tube support bar 212 with the floating type tube scraper 96 in operating position. The balloon figure indicates the tolerance 211 that would provided for the tube scraper 96 to move freely along the discharge wire electrode 90.

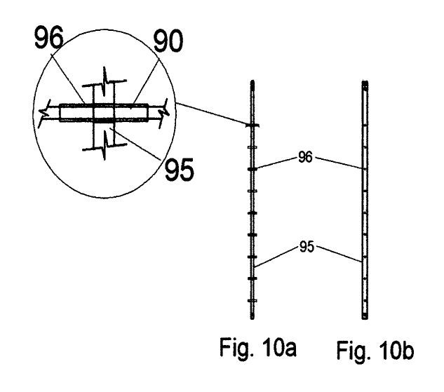

FIG. 10a shows a cross sectional side view of tube scrapers 96 and how the tube scrapers 96 are fasten to the support bar 95.

FIG. 10b shows a cross sectional front view of the bar type tube scraper assembly. This was one of the early designs for the tube type scraper and was found not to be as effective as the floating type tube scraper, FIGS. 9a, 9b and 9c. T he original scraper was narrow bar with apertures closely matching the diameter of the discharge wire.

Advantages of using horizontal discharge electrodes and/or scrapers in a vane electrostatic precipitator include:
By having the vanes at ground potential, there is no electrical field between opposing vane surfaces substantially reducing the problems associated with back corona when discharge electrodes are centrally located between collecting plates.
Emission using smaller diameter discharge electrodes facilitates energy savings.
Closeness of discharge and vane electrodes translates to energy savings.
A shorter discharge wire length electrode that follows the operating angle of vane assembles results in an even shorter wire length to be cleaned.
Horizontal discharge electrodes results in shorter discharge wire length electrodes that facilitate the use of sliding scrapers to clean the horizontal discharge wire.
The traveling support for the tubular scrapers and the mechanism used to move the tubular scraper support is located out of the main air flow, allowing for ease of maintenance.
More efficient precipitation, at least in part due to the improved cleanliness of the discharge electrodes during operation.
A smaller equipment footprint facilitates energy savings. Using vanes also allows for higher operating air velocities resulting in a smaller equipment foot print.
The main entrained air is divided into smaller proportions by using a plurality of vane and vane assemblies.
The flow rate of the air and particles are reduced as the particles abruptly change direction and traverse between and over the vane surface.
The vane width, operating angle, length, vane offset, and distance between vanes are designed to reduce the air flow rate. At the ends of the vanes a high percentage of the air flow will be less than 1 ft/s. This air flow rate at the ends of the vanes allows the particles that are discharged from the vanes during operation to fall by gravity and in the direction of lower air flow, resulting in extremely low particle re-entrainment and efficient particle collection.
Studies have shown that the width of the vanes can be relatively short. Two and three inch wide vanes have been used. Wider vanes of up to one to two feet could be used for process or structural reasons such as when the input velocity is high or there are height concerns.
An input air flow rate of 6 ft/s over the vane collecting surface can be reduced by 85%.
The concept of repeated circulation of entrained air over vanes can be used, and enough drag on both the air and particle flow can be induced, so that the charged particles will be collected on both sides of the vane surfaces.
The ability to adjust the vane operating angle and the vane assembly angle during operation. This adjustment would be effective during start up and cool down periods.
The ability to collect particles in the lower particle size range (for example, less than 2.5 microns and reduce the dependence on bag filters, (for example, related to coal ash collection requirements).
The ability to collect the higher resistivity particles by reduction in flow rate.
Intense field strengths between discharge electrode and vane leading edge facilitates better collection.
Both conductive and non-conductive particles can be collected.
A potential for operating at higher input gas velocity (four to five times greater than the prior art).
Uncharged particles can be collected by reduction in flow rate.
A broad, flexible design base of the present devices and methods can meet different processes and material requirements.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for removing particles from at least one main air stream using a vane electrostatic precipitator comprising at least one vane assembly comprising a plurality of vane type electrodes, and a plurality of horizontal discharge electrodes parallel to the vane assembly, and located on an angle matching an operating angle of the vane assembly, comprising the steps of:
(a) the plurality of vane type electrodes being at ground potential resulting in no electrical field being established between opposing vane surfaces; and
(b) establishing an electrical field between the horizontal discharge electrodes and the vane type electrodes.

2. The method of claim 1, wherein the horizontal discharge electrodes have a diameter of less than approximately 0.500 inches to reduce electrical power required for emission.

3. The method of claim 1, further comprising the step of cleaning the plurality of horizontal discharge electrodes during a precipitating process using a plurality of concentric, moveable free floating tubular scrapers or a sliding tubular bar scraper that traverse over the horizontal discharge electrodes to remove material deposited on the horizontal discharge electrodes.

4. The method of claim 1, further comprising a fork type support bar with prongs that are on each side of the free floating tube scraper that are used to move the tube scraper over the discharge wire.

5. The method of claim 1, further comprising discharge electrodes being supported at both ends and in the middle.

6. The method of claim 1, further comprising of a left and right discharge electrodes. Each with one fastened the other end not supported and open ended.

7. The method of claim 3 wherein the material removed from the horizontal discharge electrodes falls by gravity into a hopper located below the horizontal discharge electrodes and is removed by an auger into a collection device.

8. The method of claim 3, further comprising a traveling forked support bar for the tubular scrapers and a mechanism to move the traveling support, wherein the traveling support and the mechanism to move the traveling support are located out of the main air stream.

9. The method of claim 1, wherein a width of the vane electrodes is between approximately 2 inches to approximately 2 feet.

10. A vane electrostatic precipitator for removing particles from a single main air stream, comprising:
(a) at least one vane assembly comprising a plurality of vane type electrodes; and
(b) a plurality of horizontal discharge electrodes parallel to the vane assembly and located on an angle matching an operating angle of the vane assembly;
(c) wherein a polarity of the vane type electrodes are located at ground potential such that there is an electrical field established between the horizontal discharge electrodes arid the vane type electrodes and no electrical field is established between opposing vane surfaces.

11. The vane electrostatic precipitator of claim 8, wherein the horizontal discharge electrodes have a diameter of less than approximately 0.500 inches to reduce electrical power required for emission.

12. The vane electrostatic precipitator of claim 8, further comprising a plurality of concentric, moveable tubular scrapers shaped and dimensioned to fit the horizontal discharge electrodes such that the concentric, moveable tubular scrapers scrape the horizontal discharge electrodes to remove material deposited on the horizontal discharge electrodes.

13. The vane electrostatic precipitator of claim 10, further comprising a hopper located below the horizontal discharge electrodes, wherein the material removed from the horizontal discharge electrodes falls by gravity into hopper and is removed by an auger into a collection device.

14. The vane electrostatic precipitator of claim 10, further comprising a traveling support for the tubular scrapers and a mechanism to move the traveling support, wherein the traveling support and the mechanism to move the traveling support are located out of the main air stream.

15. The vane electrostatic precipitator of claim 9, wherein a width of the vane electrodes is between approximately 2 inches to approximately 2 feet.

16. A method for removing particles from a single main air stream in a vane electrostatic precipitator comprising at least one vane assembly comprising a plurality of vane type electrodes, and a plurality of horizontal discharge electrodes parallel to the vane assembly, and located on an angle matching an operating angle of the vane assembly, comprising the step of passing entrained air through the plurality of horizontal discharge electrodes and the plurality of vane type electrodes, wherein a polarity of the vane type electrodes is located at ground potential and high voltage direct current is applied to the discharge electrodes such that an electrical field is established between the horizontal discharge electrodes and the vane type electrodes and no electrical field is established between opposing vane surfaces.

17. The method of claim 14, further comprising the step of cleaning the plurality of horizontal discharge electrodes during a precipitating process using a plurality of concentric, moveable tubular scrapers that traverse over the horizontal discharge electrodes to remove material deposited on the horizontal discharge electrodes.
